(19) United States
(12) Patent Application Publication
(10) Pub. No.: US 2005/0003983 A1
(43) Pub. Date: Jan. 6, 2005

(54) Complex salt for anti-spotting detergents

(76) Inventors: Dong Gyu Kim, Bucheon-city (KR); Young Ki Sohn, Seoul (KR); Jang Hyuck Park, Seoul (KR); Won Chul Choi, Incheon-city (KR); Kyung Sik Joo, Incheon-city (KR); Dong Tak Lee, Seoul (KR); Yun Taek Jung, Seoul (KR)

Correspondence Address: CANTOR COLBURN, LLP, 55 GRIFFIN ROAD SOUTH, BLOOMFIELD, CT, 06002, US

(21) Appl. No.: 10/897,736

(22) Filed: Jul. 22, 2004

Related U.S. Application Data
(63) Continuation of application No. 10/659,668, filed on Sep. 10, 2003.

(30) Foreign Application Priority Data
Sep. 11, 2002 (KR) 2002-54938

(51) Int. Cl. C11D 3/00

(52) U.S. Cl. 510/301

(57) ABSTRACT

Provided is a method of using a complex salt as anti-spotting detergents, the complex salt being formed by the reaction of a photo-bleaching component having a water-soluble anionic substituent and a cationic surfactant. The complex salt is water insoluble in a stationary state, such as hand washing or pre-soaking for machine washing, so it effectively suppress the spotting of the photo-bleaching component into the interwoven webs of fabric. In addition, the complex salt can uniformly and rapidly dissolve in an agitating state, such as when machine washing, to allow the photo-bleaching component to absorb into fabric for effective bleaching and enhanced detergency.

### CROSS-REFERENCE TO RELATED APPLICATIONS

This application is a continuation of U.S. patent application Ser. No. 10/659,668 filed Sep. 10, 2003, which claims the priority of Korean Patent Application No. 2002-54938, filed on Sep. 11, 2002, in the Korean Intellectual Property Office, the contents of which are incorporated by reference herein in their entirely.

### BACKGROUND OF THE INVENTION

1. Field of the Invention

The present invention relates to a complex salt for anti-spotting detergents, and more particularly, to a complex salt for anti-spotting detergents, which includes a photo-bleaching component that does not chemically react with fabric in a stationary state, such as hand washing or pre-soaking for machine washing, to prevent spotting and which adheres to fabric in an agitating state, such as when machine washing.

2. Description of the Related Art

Recently, bleaching agents, such as metallo porphrins, metallo phthalocyanines, metallo naphthalocyanines, etc., have been intensively researched.

Metallo phorphrin, metallo phthalocyanine, and metallo naphthalocyane, which originally exclusively have hydrogen in their parent ring, are generally used as a pigment for coloring and have no effect as a detergent.

Methods for using these compounds in bleaching and washing are disclosed in European Patent Nos. 553,607; 553,608; 596,184; 596,186; 596,187; and 692,947. According to these methods, three or more hydrophilic substituent groups are attached to the parent groups of the compounds for water solubility.

U.S. Pat. No. 3,927,967 discloses the use of photoactive zinc phthalocyanine sulfonate in a granular detergent.

Such a photo-bleaching agent can absorb electromagnetic radiation in a visible range and can emit energy quantum absorbed into fabric for bleaching effects. The energy quantum is considered to generate highly oxidative singlet oxygen. Some photoactive agents, such as zinc phthalocyanine sulfonate and aluminum phthalocyanine sulfonate, are proven to be commercially applicable in the field of granular detergent compositions.

However, such metallo porphrins, metallo phthalocyanines, and metallo naphthalocyanines having water-soluble substitutent groups lead to green or blue spotting, which are typical colors of photo-bleaching agents, under particular washing conditions. Such spotting is frequent when hand washing or when the wash is socked before machine washing while a detergent is not fully dissolved.

In other words, since the photo-bleaching metallo porphrins, metallo phthalocyanines, and metallo naphthalocyanines having water-soluble substituents originally have the function of green or blue pigments, spotting is highly likely to occur when used with natural fabric, such as cotton, rayon, and silk, by hydrogen bonds and van der Waals force. Most users generally soak the wash in a detergent solution containing a photo-bleaching agent not fully dissolved for hand washing or as pre-treatment before machine washing. However, the photo-bleaching agent, initially not fully dissolved in the detergent solution, dissolves in time into the water layer of the solution and the wash, forming apparent spots of photo-bleaching agent-specific green or blue color on the wash and making the user to complain.

European Patent No. 0119746 discloses a method of adding a water-soluble photo-bleaching agent into a detergent composition, in which a diluted solution of the photo-bleaching agent is sprayed into the detergent composition. However, this method is considered to be ineffective due to the affinity of the photo-bleaching agent with fabric. As an improved method, the photo-bleaching agent is uniformly mixed with the entire volume of detergent composition to eliminate local over-concentration. However, the detergent composition prepared with this method has an unpleasant color unlike common detergents, thereby affecting consumer marketing. The method can reduce the degree of spotting, compared to the other methods, due to a dilution effect, but it is still incomplete.

Due to the problem of spotting, photo-bleaching agents for washing detergents, particularly for granular detergents, have been practically added a trace that does not effect bleaching.

Korean Patent No. 96-14750 discloses micro-encapsulation of a photo-bleaching component with its carrier material insoluble in a nonionic surfactant for rapid solubilization in cold water. However, solublizing the photo-bleaching composition fast as presented in this method fails to yield a perfect solution for the slotting problem, in view of the typical affinity of photo-bleaching agent with fabric. In the worse case, the method is likely to lead to more serious spotting depending on the ingredient combination and washing conditions. This has been experimentally confirmed by the present inventors using commercially available microencapsulated products.

### SUMMARY OF THE INVENTION

The present invention provides a complex salt for anti-spotting detergents, the complex salt containing a photo-bleaching agent that is water-insoluble in a stationary state to prevent chemical reactions with fabric. The complex salt rapidly uniformly dissolves in an agitating state or a turbulent water flow as during machine washing, strongly adsorbs into fabric, and provides good photo-bleaching effect under daylight drying conditions.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph of absorbance for a complex salt compound prepared in Example 1 according to the present invention;

FIG. 2 is a graph of absorbance for a complex salt compound prepared in Example 2 according to the present invention;

FIG. 3 is a graph of absorbance for a complex salt compound prepared in Example 3 according to the present invention; and

FIG. 4 is a graph of absorbance for a sodium salt of zinc phthalocyanine tetrasulfonate for comparison.

### DETAILED DESCRIPTION OF THE INVENTION

The present invention provides a complex salt for washing that prevents spotting by photo-bleaching components, which is generated by the reaction of a photobleach compound having a water-soluble anionic substituent and a cationic surfactant.

The cationic surfactant forms a water-nearly insoluble complex salt by the reaction with the photobleach compound. Suitable examples of the cationic surfactant include the quaternary ammonium compounds of formulae (1), (2), and (3) below. 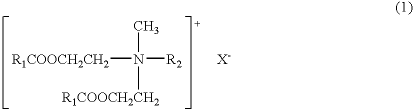
wherein R₁ is a substituted or unsubstituted C₈-C₂₂ alkyl group or a substituted or unsubstiuted C₈-C₂₂ alkenyl group; R₂ is a substituted or unsubstituted C₁-C₄ alkyl group; and X is selected from among a halogen atom, acetate, phosphate, nitrate, and methyl sulfate. 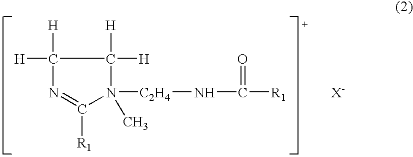
wherein R₁ and X are the same as defined above. 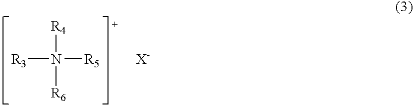
wherein R₃ is selected from among a hydrogen atom, a substituted or unsubstituted C₁-C₂₂ alkyl, and a substituted or unsubstituted C₁-C₂₂ alkenyl group; R₄ is one of a substituted or unsubstituted C₈-C₂₂ alkyl group and a substituted or unsubstituted C₈-C₂₂ alkenyl group; each of R₅ and R₆ is a C₁-C₄ alkyl group; and X is selected from among a halogen atom, acetate, phosphate, nitrate, and methyl sulfate.

The compound of formula (1), a preferred example of the cationic surfactant according to the present invention, is an ester form of quaternary ammonium compound, so called “esterquat”. This compound has one or more long-chain hydrophobic alkyl or alkenyl group substituted by a carboxyl group. The compound of formula (1) is widely known, as disclosed in European Patent No. 239,910 or International Patent No. WO95/24460. A representative example of the compound of formula (1) includes methyl triethanol ammonium methyl sulfate dioleyl ester.

Preferred examples of the compound of formula (2) that can be used as a cationic surfactant in the present invention include, without limitation, 1-methyl-1-[(steroylamido)ethyl]-2-octadecyl4,5-dihydroimidazolinium chloride, 1-methyl-1-[(oleylamino)ethyl]-2-oleyl-4,5-dihydroimidazolinium methyl sulfate, 1-methyl-1-[(tallowamido)ethyl]-2-tallow-4,5-imidazolinium chloride, 1-methyl-1-[(palmitoylamido)ethyl]-2-octadecyl-4,5-dihydroimidazolinium chloride, 1-methyl-1-[(steroylamide)ethyl]-2-octadecyl-4,5-dihydroimidazolinium chloride, and 1-methyl-1-[(hydrogenated tallowamido)ethyl]-2-hydrogenerated tallow-4,5-imidazolinium chloride.

Suitable examples of the compound of formula (3) that can be used in the present invention include, without limitation, tallow trimethyl ammonium chloride, ditallow dimethyl ammonium chloride, ditallow dimethyl ammonium methyl sulfate, dihexadecyl diemethyl ammonium chloride, di(hydrogenated tallow)dimethyl ammonium chloride, dioctadecyl dimethyl ammonium chloride, distearyl dimethyl ammonium chloride, dicosyl dimethyl ammonium chloride, didocosyl dimethyl ammonium chloride, di(hydrogenated tallow)dimethyl ammonium methyl sulfate, dihexadecyl diethyl ammonium chloride, dihexadecyl dimethyl ammonium acetate, ditallow dipropyl ammonium phosphite, ditallow dimethyl ammonium nitrate, and di(coconut-alkyl)dimethyl ammonium chloride.

Another essential component of the present invention is a water-soluble photobleaches having an anionic substituent. Examples of a detergent-grade water-soluble bleaching component having an anionic substituent in its parent ring that can be used in the present invention include ones disclosed in European Patent Nos. 553,607; 553,608; 596,184; 596,186; 596,87; and 692947, wherein their anionic substitutent can form a complex salt with a cationic surfactant.

Any detergent-grade photobleaches, for example, metallo porphrins, metallo phthalocyanines, and methallo naphthalocyanines, can be used without limitation. However, water-soluble metallo phthalocyanines having an anionic substituent is preferred, and zinc phthalocyanine sulfonate or aluminum phthalocyanine sulfonate is more preferred.

Complex Salt Preparation Method

A complex salt of a water-insoluble photo-bleaching component can be derived simply using the photobleaching compound having an anionic substituent and a cationic surfactant with the ability to form a water-insoluble complex with the photo-bleaching component, but preferably through the reaction in a solvent which allows at least one of the photo-bleaching component, the cationic surfactant, and the resulting complex salt to dissolve therein.

1-100 moles on average of the cationic surfactant forming a complex salt with the photo-bleaching component is used with respect to 1 mole of the photobleaching compound having an anionic substituent. It is preferable to use 4-40 moles of the cationic surfactant with respect to 1 mole of the photobleaching compound so as to form complex salts with all of the anionic substituents in the parent ring of the photo-bleaching component. The complex salt is obtained by a reaction in a solvent which allows one of the cationic surfactant, the photo-bleaching component, and the resulting complex salt to dissolve therein.

Any common solvent used in preparing detergents can be used without limitation. However, solvents which allow at least one of the photo-bleaching component, the cationic surfactant, and the resulting complex salt to dissolve or become soluble therein are preferred. Examples of such a solvent include mixtures of at least one selected from the group consisting of water; lower alcohols, such as ethanol, propaneol, isopropanol, etc.; polyvalent alcohols, such as glycerol, propylene glycol, etc.; alkyl polyglycosides, such as decyl polyglucose, dodecyl polyglucose, etc.; higher aliphatic alcohols having 12 or more carbon atoms; fatty acids; polyoxyethylene; and nonionic surfactants.

The amount of the solvent is determined based on the reaction time, the production rate of complex salt, the method of applying the complex salt to a granular detergent. The appropriate amount of the solvent is in the range of, preferably 5-95% by weight, more preferably 10-90% by weight, most preferably 20-90% by weight, based on the total weight of the solvent, the photo-bleaching component, and the cationic surfactant.

The original water solubility of the photo-bleaching component before reaction fully or mostly disappears after the formation of the complex salt, so that the complex salt dissolves more easily in non-polar organic solvents, such as chloroform or dichloromethane, than in water.

A preferred example of the solvent is a nonionic surfactant known to be useful for fabric detergents. Suitable commercially available nonionic surfactants are derived from the condensation of alkylene oxide or analogs thereof with a hydrophobic compound. This hydrophobic compound may be an aliphatic or aromatic compound, but preferably a mixture of aliphatic and aromatic compounds. Suitable aromatic compounds include higher aliphatic alcohols, higher alkylphenols, carboxylic acids, carboxyamides, mercaptans, sulfonylamides, and the like, with the higher aliphatic alcohols and higher alkylphenols being preferred. A preferred nonionic surfactant is a polycondensed product of a higher alkylphenol or higher aliphatic alcohol with ethylene oxide.

The hydrophobic compound absolutely requires at least about six, preferably, at least about eight carbon atoms. A preferred range of the number of carbon atoms is from about 8 to about 22. The hydrophobic compound may have 10-18 carbon atoms for aliphatic alcohols and 12-20 carbon atoms for higher alkylphenols. The amount of the alkylene oxide varies considerably depending on the hydrophobic compound. According to general practical rules, the alkylene oxide is used in an amount of at least about 3-200 moles, and preferably, about 5-50 moles, based on 1 mole of the hydrophobic compound, for a desired solubility and improved detergency or compatibility with other components.

Preferred types of the nonionic surfactant include the compounds of formulae (4) and (5).
R₇O(CH₂CH₂O)ₘH (4)
wherein R₇ is a C₈-C₂₂ primary or secondary alkyl group, and m is an integer from 5 to 50. 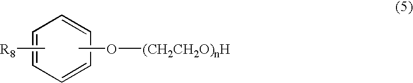
wherein R₈ is a C₄-C₁₂ primary or secondary alkyl group, and n is an integer from 5 to 50.

In the compound of formula (4), R₇ is a primary or secondary alkyl group with about 8 to 22 carbon atoms, preferably, 10 to 18 carbon atoms, and more preferably a primary or secondary alkyl groups with 12 to 15 carbon atoms or a mixture thereof.

In the compound of formula (5), R₈ is a primary or secondary alkyl group with 4 to 12 carbon atoms, preferably 8 to 12 carbon atoms, and more preferably, an octyl, isooctyl, or nonyl group with 8 to 9 carbon atoms.

Suitable alcohols for use in the synthesis of the compound of formula (4) includes, preferably, lauryl alcohol, myristyl alcohol, cetyl alcohol, stearyl alcohol, oleyl alcohol, and mixtures of the forgoing alcohols. A typical example of the nonionic surfactant of formula (5) is a lauryl alcohol condensed with 5-11 mol of ethylene oxide. A typical example of the nonionic surfactant of formula (6) is an isooxyphenol or nonylphenol condensed with 3-8 mol of eethylene oxide.

Other usable examples of the nonionic surfactant include polyoxyalkylene ethers of organic acids, such as higher fatty acids, rosin acid, tall oil fatty acid, petroleum oxide-derived acids, etc. These esters contain about 3-40 mol of ethylene oxide or an analog thereof and an acid portion with about 10 to 22 carbon atoms.

Another usable surfactant is a condensed product of higher fatty acid amide or an analog thereof with alkylene oxide. The fatty acid portion of the higher fatty acid amide contains about 8 to 22 carbon atoms and is preferably condensed with about 3-40 mol of ethylene oxide. A nonlimiting analog of the higher fatty acid amide is alkyl sulfonyl amide.

When the complex salt compound prepared as described above is added into a granular detergent, it can suppress spotting occurring as a result of the permeation of the photo -bleaching component into the interwoven webs of fabric when the wash remains stationary, for example, in a solution for hand washing. In addition, the complex salt can uniformly and rapidly dissolve and adhere to fabric in the operating conditions of general washing machine to effect bleaching and washing.

The complex salt compound for addition into a granular detergent contains 0.001-0.5% by weight, preferably, 0.001-0.1% by weight, of a photo-bleaching component based on the total weight of the complex salt.

Methods of Applying the Complex Salt into a Granular Detergent

The complex salt compound derived by the reaction of a photo-bleaching component and a cationic surfactant as described above may be added by nozzle spraying into a granular detergent composition in a rotating drum mixer or on a moving conveyer belt. Alternatively, the complex salt may be granulated before addition.

In a specific embodiment of the granulation method, the complex salt may be granulated with the addition of an oil-absorbing material, such as carbonate, silicate, crystalline silicate, silica, A, P, and X types of zeolite, and a binder such as a nonionic surfactant and polyoxyethylene, using a batch type mixer or a continuous mixer. Available examples of a batch type mixer include Ribbon Mixer, Nauta Mixer (HOSOKAWA MICRONS CO.), V-mixer, Henschel mixer, a pan pelletizer, a high-speed mixer, Lodige Mixer, and the like. Available examples of a continuous mixer include Kettemix Reactor (BALLESTRA CO.), Flexomix (HOSOKAWA MICRONS CO.), Flowjet Mixer, and the like.

The granular complex salt so produced is stored in a hopper for use in, for example, the continuous manufacture of detergents. An amount of the granular complex salt is measured and added into a granular detergent carried over a conveyer belt.

According to the present invention, a granular detergent composition including the above complex salt may further contain common detergent ingredients, such as an organic surfactant, a detergency enhancer, and a general auxiliary detergent. The amount of the organic surfactant may be in the range of 1-60% by weight based on the total weight of the granular detergent composition.

Throughout the specification of the present invention, the term “substituted or unsubstituted C₁-C₄ alkyl group” means both straight and branched radicals, wherein at least one hydrogen atom of the radical may be substituted with a halogen atom, a hydroxy group, a carboxyl group, a cyano group, an amino group, and the like. Preferred examples of these radicals include methyl, ethyl, n-propyl, isopropyl, n-butyl, isobuyl, sec-butyl, tert-butyl, and the like.

The term “substituted or unsubstituted C₁-C₂₂ alkyl group” means both straight and branched radicals, wherein at least one hydrogen atom of the radical may be substituted with a halogen atom, a hydroxy group, a carboxy group, a cyano group, an amino group, and the like. Preferred examples of these radicals include methyl, ethyl, n-propyl, isopropyl, n-butyl, isobuyl, sec-butyl, tert-butyl, pentyl, isoamyl, hexyl, octyl, isooctyl, nonyl, lauryl, myristyl, cetyl, stearyl, and the like.

The term “substituted or unsubstituted C₈-C₂₂ alkyl group” means both straight and branched radicals, wherein at least one hydrogen atom of the radical may be substituted with a halogen atom, a hydroxy group, a carboxyl group, a cyano group, an amino group, and the like. Preferred examples of these radicals include octyl, isooctyl, nonyl, lauryl, myristyl, cetyl, stearyl, and the like.

The term “substituted or unsubstituted C₄-C₁₂ alkyl group” means both straight and branched radicals, wherein at least one hydrogen atom of the radical may be substituted with a halogen atom, a hydroxy group, a carboxyl group, a cyano group, an amino group, and the like. Preferred examples of these radicals include n-butyl, isobutyl, sec-butyl, tert-butyl, pentyl, isoamyl, hexyl, octyl, isooctyl, nonyl, lauryl, and the like.

The term “substituted or unsubstituted C₁-C₂₂ alkenyl group” means both straight and branched radicals substituted by arbitrary one or more hetero atoms and having at least one carbon-carbon double bond, wherein at least one hydrogen atom of the radical may be substituted with a halogen atom, a hydroxy group, a carboxyl group, a cyano group, an amino group, and the like. Preferred examples of these radicals include allyl, 1-butenyl, 1-methyl-2-propenyl, 4-pentenyl, oleyl, and the like.

The term “substituted or unsubstituted C₈-C₂₂ alkenyl group” means both straight and branched radicals substituted by arbitrary one or more hetero atoms and having at least one carbon-carbon double bond, wherein at least one hydrogen atom of the radical may be substituted with a halogen atom, a hydroxy group, a carboxyl group, a cyano group, an amino group, and the like. Preferred examples of these radicals include oleyl, etc.

The present invention will be described in greater detail with reference to the following examples. The following examples are for illustrative purposes and are not intended to limit the scope of the invention.

### EXAMPLE 1

### Complex Salt Preparation (1)

1400 g of methyl triethanol ammonium ethylsulfate dioleylester as a cationic surfactant having formula (1) above was added into 2300 g of polyoxyethylene lauryl ether (EO=7 mol), heated to 60., and allowed to fully dissolve. 300 g of a 16%-aqueous solution of a sodium salt of zinc phthalocyanine tetrasulfonate as a photo-bleaching agent was dropped into the mixture over 5 minutes while stirring to provide a homogeneous, dark greenish blue solution.

### EXAMPLE 2

### Complex Salt Preparation (II)

1000 g of 1-methyl-1-[(oleylamido)ethyl]-2-oleyl-4,5-dihydroimidazolinum methyl sulfate as a cationic surfactant having formula (2) above was added into 2300 g of polyoxyethylene lauryl ether (EO=7 mol), heated to 60., and allowed to fully dissolve. 300 g of a 16%-aqueous solution of a sodium salt of zinc phthalocyanine tetrasulfonate as a photo-bleaching agent was dropped into the mixture over 5 minutes while stirring over 5 minutes to provide a homogeneous, dark greenish blue solution.

### EXAMPLE 3

### Complex Salt Preparation (II)

1400 g of dimethyl distearyl ammonium chloride as a cationic surfactant having formula (3) above was added into 2300 g of polyoxyethylene lauryl ether (EO=7 mol), heated to 60., and allowed to fully dissolve. 300 g of a 16%-aqueous solution of a sodium salt of zinc phthalocyanine tetrasulfonate as a photo-bleaching agent was dropped into the mixture over 5 minutes while stirring to provide a homogeneous, dark greenish blue solution.

### EXAMPLE 4

### Complex Salt Confirmation

The absorbance of each of the complex salt compounds obtained in Examples 1 through 3 was measured in the following conditions.

<Experimental Equipment and Reagent >

1) 300-mL separating funnel

2) Chloroform (MERCK, HPLC-grade)

3) Water (deionized to 18 Mohm, MILLIPORE)

4) Magnetic stirrer

5) 200-mL beaker

<Experimental Condition >

1) UV/V is spectrophotometer (HEWLETT PACKARD, HP8452)

2) UV scan range: 190-800 nm

3) UV cell: 1×2 cm quartz cell

<Experimental Result >

100 mL of each of the complex salt compounds manufactured in Examples 1 through 3 was dispersed in a mixture of 100 mL of deionized water and 100 mL of chloroform and mixed thoroughly in a separating funnel for phase separation. The chloroform layer containing the complex salt was extracted and analyzed using a UV spectrometer after concentration adjustment.

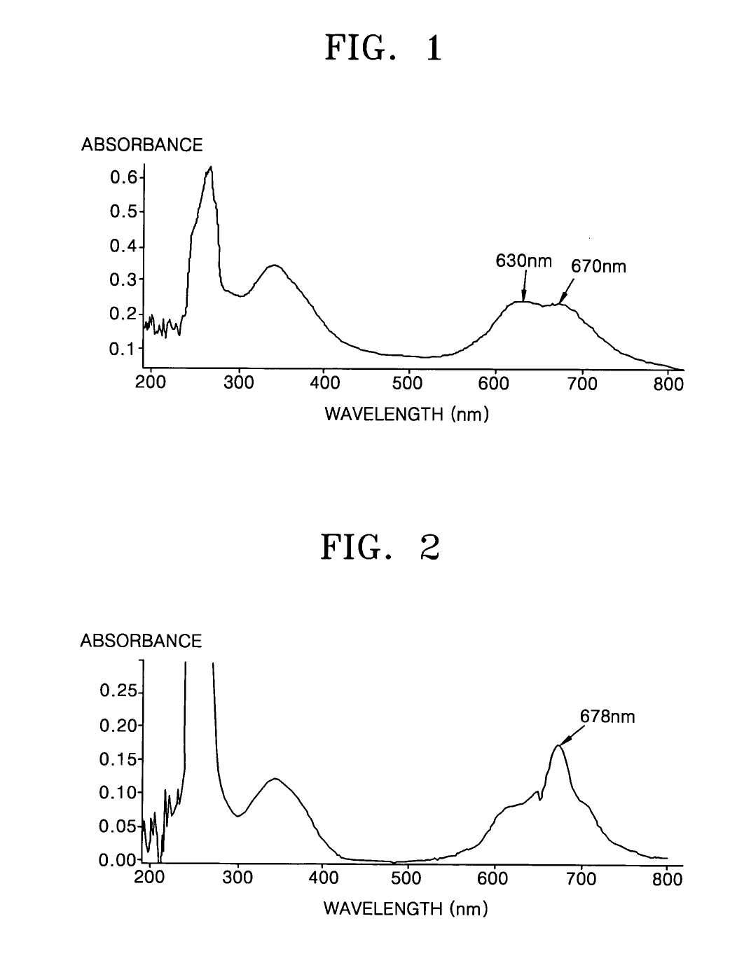

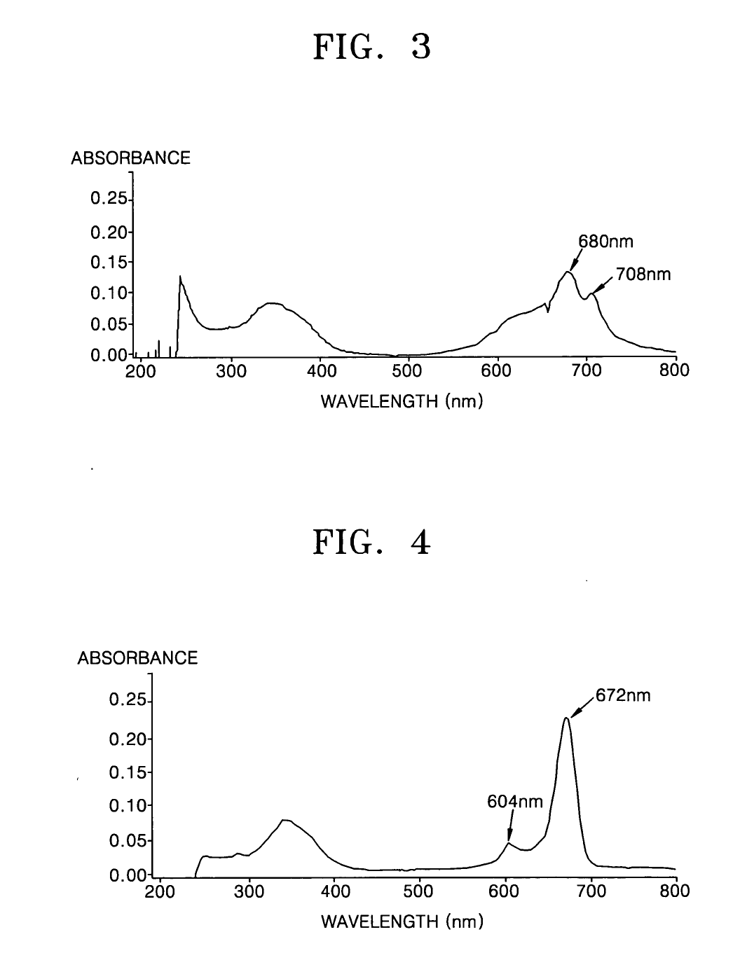

The results of UV scanning on each of the complex salt compounds are shown in FIGS. 1 through 3. For comparison, the absorbance of the aqueous solution of sodium salt of zinc phthalocyanine tetrasulfonate is shown in FIG. 4.

As is apparent from FIGS. 1 through 4, the UV spectra of the complex salt compounds according to the present invention appear to be slightly different from the UV spectrum of the aqueous solution of sodium salt of zinc phthalocyanine tetrasulfonate, wherein there is a slight shifting of the peak UV absorption wavelength. Further, it is confirmed that the complex salt compounds according to the present invention is water-insoluble and is highly soluble in non-aqueous solvents, such as chloroform.

### EXAMPLE 5

### Preparation of Complex Salt-Containing Granular Detergents

For an application of the complex salt compound prepared in the above examples to detergents, a granular detergent with the composition of Table 1 below was prepared.

TABLE 1

| Component | Content (%) |
|---|---|
| Linear alkyl benzene sulfonate | 18 |
| -olefin alkyl sulfonate | 14 |
| Polyoxyethylene alkyl ether | 3 |
| (7 mole of ethylene oxide) | |
| Sodium carbonate | 28 |
| Glauber's salt | 5 |
| Zeolite A | 25 |
| Water | 6 |
| Fluorescent brightener | 0.5 |
| Enzyme | 0.5 |

A fluorescent brightener manufactured by Ciba Specialty Chemicals Co. with the trade name of Tinopal CBS-X and an enzyme manufactured by NOVO Nordisk Co. with the trade name of Savinase 12T were used.

The complex salt compound manufactured in Example 1 was sprayed into the granular detergent having the above composition using a spray nozzle according to the following compositions on a weight basis in Table 2 to provide complex salt-containing granular detergents.

TABLE 2

| Component | A | B | C |
|---|---|---|---|
| Granular detergent having the | 99.5% | 98.5% | 97.5% |
| composition of Table 1 | | | |
| Complex salt compound of | 0.5% | 1.5% | 2.5% |
| Example 1 | | | |

### COMPARATIVE EXAMPLE 1

### Preparation of Granular Detergents that Contain a Photo-Bleaching Component but Does not Contain a Complex Salt

To compare the effects of the complex salt according to the present invention with the effects of photo-bleaching components, granular detergents containing a phot beaching agent without the complex salt were prepared as follows.

300 g of a 16%-aqueous solution of sodium salt of zinc phthalocyanine tetrasulfonate sodium salt, which was used in Example 1 as a photo-bleaching agent, was mixed together with 3700 g of polyoxyethylene lauryl ether (EO=7 mol). This mixture was sprayed using a spray nozzle into the granular detergent having the composition of Table 1 in Example 5 according to the compositions on a weight basis in Table 3 to provide photo-bleaching agent-containing granular detergents, in which the complex salt according to the present invention was not contained.

TABLE 3

| Component | D | E | F |
|---|---|---|---|
| Granular detergent with the | 99.5% | 98.5% | 97.5% |
| composition of Table 1 | | | |
| Added amount | 0.5% | 1.5% | 2.5% |

In addition, commercially available granular detergents, Ariel Essential and ACE (both available from Procter & Gamble Co.), were used for comparison tests as in the following experimental example.

### EXPERIMENTAL EXAMPLE

The following tests were conducted using the granular detergents of Example 5, which contained the complex salt of Example 1, the granular detergents of Comparative Example 1, which contained only photo-bleaching agent without the complex salt, and Ariel Essential and Ace (commercially available from Procter & Gamble Co.).

(1) Spotting Test

The following experiment was conducted to investigate the probability of appearance of spotting under inadequate washing conditions. The results are shown in Table 4.

Three sheets of white cotton cloth (6×6 cm standard white cotton cloth of Korea Apparel Testing and Research Institute) were placed in each of a plurality of Petri dishes, and the granular detergents of Example 5, which contained the complex salt, and the granular detergents of Comparative Example 1, which contained only a photo-bleaching agent without the complex salt, and the two commercially available detergents were applied to the white cotton cloth in the Petri dishes, respectively, in which 10 g of each of the detergents was sprayed over the white cotton cloth.

After adding 100 mL of tap water, the Petri dishes were left for 30 minutes, 1 hour, 2 hours, 4 hours, 8 hours, and 12 hours. The white cotton cloth was rinsed in flowing water after each of the durations and dried in a hot air drier at 50. for 30 minutes. The degree of spotting was evaluated on a 5-point as follows; 5 for severe on all of the upper, middle, and lower layers of the cotton cloth; 4 for severe on the upper layer, moderate on the middle layer, and slight on the lower layer; 3 for moderate on the upper layer, slight on the middle layer, and almost none on the lower layer; 2 for slight on the upper layer and none on the middle and lower layers; and 1 for none on all of the upper, middle, and lower layers.

TABLE 4
Spotting Test Results

| | Com- | | | | | |
|---|---|---|---|---|---|---|
| Sample | position | 30 min | 1 hr | 2 hr | 4 hr | 8 hr |
| Granular detergents | A | 1 | 1 | 2 | 2 | 3 |
| of Example 5 | B | 1 | 1 | 2 | 2 | 3 |
| | C | 1 | 1 | 2 | 2 | 3 |
| Granular detergents | D | 4 | 5 | 5 | 5 | 5 |
| of Comparative | E | 5 | 5 | 5 | 5 | 5 |
| Example 1 | F | 5 | 5 | 5 | 5 | 5 |
| Commercially available | Ariel | 2 | 3 | 4 | 5 | 5 |
| granular detergents | Ace | 3 | 4 | 5 | 5 | 5 |

As is apparent in Table 1, for the granular detergents containing the complex salt, which was produced by the substitution of a cationic surfactant for the water-soluble metal salt of a photo-bleaching component, excellent anti-spotting effects appear regardless of the amount of the photo-bleaching agent.

(2) Photo-Bleaching Effect Test

The photo-bleaching effect was tested using the granular detergents of Example 5, which contained the hydrophobic complex salt of Example 1, and the granular detergents of Comparative Example 1, which contained a hydrophilic photo-bleaching agent, in terms of solubility and the degree of adsorption of the photo-bleaching agent to fabric in general washing conditions.

Sample clothes (BC-1) for the bleaching test were cut to a size of 7×7 cm. The sample clothes were washed with the granular detergents in an standard amount of 0.67 g/L each using a detergency tester (Terg-o-temeter) at a temperature of 25. and a rotor speed of 120 rpm for 10 minutes, followed by rinsing two times with 1 L of water each for 3 minutes. The washed sample cloths were left under the illumination of a 1 700-LUX incandescent bulb and dried for 2 hours, in which a sufficient amount of water was sprayed over each sample cloth at 1 0-min intervals during drying. Change in Y-value before and after washing was measured on each sample cloth after drying using a colormeter (DataColor International Co., SF500).

The bleaching effect after repeated washings was evaluated after washing five times.

For comparison, the above bleaching effect test was performed using water without detergent and the granular detergent having the composition of Table 1 that contained no photo-bleaching agent.

TABLE 5
Results of Photo-bleaching Effect Test (Dark Drying)

| | Com- | | | | | |
|---|---|---|---|---|---|---|
| Sample | position | 1 time | 2 times | 3 times | 4 times | 5 times |
| Granular | A | 0.65 | 1.45 | 3.65 | 4.85 | 6.15 |
| detergents | B | 0.68 | 1.50 | 3.36 | 4.89 | 6.20 |
| of Example 5 | C | 0.62 | 1.49 | 3.45 | 4.86 | 6.12 |
| Granular | D | 0.63 | 1.53 | 3.52 | 4.98 | 6.03 |
| detergents | E | 0.64 | 1.49 | 3.46 | 5.03 | 6.26 |
| of Comparative | F | 0.68 | 1.52 | 3.36 | 5.01 | 6.23 |
| Example 1 | | | | | | |

| | | | | | |
|---|---|---|---|---|---|
| Washing without | 0.42 | 0.95 | 2.11 | 3.19 | 4.40 |
| detergent | | | | | |
| Granular detergent with | 0.62 | 1.33 | 2.50 | 4.02 | 5.40 |
| the composition of | | | | | |
| Table 1 | | | | | |

TABLE 6
Results of Photo-bleaching Effect Test (Drying under
illumination)

| | Com- | | | | | |
|---|---|---|---|---|---|---|
| Sample | position | 1 time | 2 times | 3 times | 4 times | 5 times |
| Granular | A | 0.85 | 2.65 | 5.36 | 7.98 | 10.52 |
| detergents of | B | 0.83 | 2.82 | 5.36 | 8.02 | 10.23 |
| Example 5 | C | 0.79 | 2.95 | 5.55 | 7.92 | 10.02 |
| Granular | D | 0.85 | 2.65 | 5.32 | 8.05 | 10.52 |
| detergents | E | 0.92 | 2.78 | 5.36 | 8.12 | 10.25 |
| of Comparative | F | 0.86 | 2.98 | 5.46 | 7.95 | 9.96 |
| Example 1 | | | | | | |

| | | | | | |
|---|---|---|---|---|---|
| Washing without | 0.72 | 1.16 | 2.33 | 3.48 | 4.78 |
| detergent | | | | | |
| Granular detergent with | 0.61 | 2.06 | 3.99 | 6.17 | 8.27 |
| the composition of | | | | | |
| Table 1 | | | | | |

As is apparent from Tables 5 and 6, the granular detergents containing the hydrophobic complex salt according to the present invention, which is derived by the reaction of the water-soluble photo-bleaching component and the cationic surfactant, do not react with fabric in a stationary state and adsorbs into the fabric to provide the photo-bleaching effect after drying under illumination as in the sun.

As described above, when the complex salt according to the present invention, which is obtained as a result of the reaction of a photo-bleaching component and a cationic surfactant, is used to form a detergent, the spotting of the photo-bleaching agent into the interwoven webs of fabric is suppressed. In addition, the complex salt according to the present invention uniformly and rapidly dissolves in general washing conditions, strongly adsorbs into fabric, and provide enhanced detergency. Therefore, the complex salt according to the present invention has wide applications in the field of laundry detergents.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of using a complex salt as an anti-spotting detergent, comprising:
reacting the complex salt with a photo-bleaching component having a water-soluble anionic substituent and a cationic surfactant.

2. The method of claim 1, wherein the photo-bleaching component having the water-soluble substituent is at least one of a metallo porphrin, a metallo phthalocyanine, a metallo naphthalocyanine, and a combination of the forgoing materials.

3. The method of claim 2, wherein the metallo phthalocyanine is at least one of zinc phthalocyanine sulfonate and aluminum phthalocyanine sulfonate.

4. The method of claim 1, wherein the cationic surfactant is a quaternary ammonium compound having one of formulae (1), (2), and (3) below: 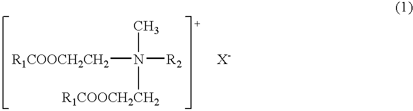
wherein R₁ is a substituted or unsubstituted C₈-C₂₂ alkyl group or a substituted or unsubstiuted C₈-C₂₂ alkenyl group; R₂ is a substituted or unsubstituted C₁-C₄ alkyl group; and X is selected from among a halogen atom, acetate, phosphate, nitrate, and methyl sulfate; 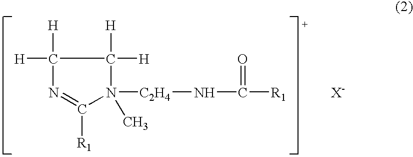
wherein R₁ is a substituted or unsubstituted C₈-C₂₂ alkyl group or a substituted or unsubstiuted C₈-C₂₂ alkenyl group; and X is selected from among a halogen atom, acetate, phosphate, nitrate, and methyl sulfate; and 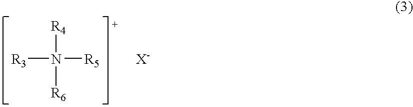
wherein R₃ is selected from among a hydrogen atom, a substituted or unsubstituted C₁-C₂₂ alkyl, and a substituted or unsubstituted C₁-C₂₂ alkenyl group; R₄ is one or a substituted or unsubstituted C₈-C₂₂ alkyl group and a substituted or unsubstituted C₈-C₂₂ alkenyl group; each of R₅ and R₆ is a C₁-C₄ alkyl group; and X is selected from among a halogen atom, acetate, phosphate, nitrate, and methyl sulfate.

5. The method of claim 4, wherein the cationic surfactant of said formula (2) is selected from among the group consisting of 1-methyl-1-[(steroylamido)ethyl]-2-octadecyl-4,5-dihydroimidazolinium chloride, 1-methyl-1-[(oleylamino)ethyl]-2-oleyl-4,5-dihydroimidazolinium methyl sulfate, 1-methyl-1-[(tallowamido)ethyl]-2-tallow-4,5-imidazolinium chloride, 1-methyl-1-[(palmitoylamido)ethyl]-2-octadecyl-4,5-dihydroimidazolinium chloride, 1-methyl-1-[(steroylamide)ethyl]-2-octadecyl-4,5-dihydroimidazolinium chloride, and 1-methyl-1-[(hydrogenated tallowamido)ethyl]-2-hydrogenerated tallow-4,5-imidazolinium chloride.

6. The method of claim 4, wherein the cationic surfactant of said formula (3) is selected from the group consisting of tallow trimethyl ammonium chloride, ditallow dimethyl ammonium chloride, ditallow dimethyl ammonium methyl sulfate, dihexadecyl diemethyl ammonium chloride, di(hydrogenated tallow)dimethyl ammonium chloride, dioctadecyl dimethyl ammonium chloride, distearyl dimethyl ammonium chloride, dicosyl dimethyl ammonium chloride, didocosyl dimethyl ammonium chloride, di(hydrogenated tallow)dimethyl ammonium methyl sulfate, dihexadecyl diethyl ammonium chloride, dihexadecyl dimethyl ammonium acetate, ditallow dipropyl ammonium phosphite, ditallow dimethyl ammonium nitrate, and di(coconut-alkyl)dimethyl ammonium chloride.
